(19) United States
(12) Patent Application Publication
(10) Pub. No.: US 2019/0202360 A1
(43) Pub. Date: Jul. 4, 2019

(54) EXTERIOR MIRROR ASSEMBLY

(71) Applicant: Gentex Corporation, Zeeland, MI (US)

(72) Inventors: Brett C. Pothoof, Allendale, MI (US); Bradley R. Hamlin, Allendale, MI (US)

(73) Assignee: Gentex Corporation, Zeeland, MI (US)

(21) Appl. No.: 16/227,638

(22) Filed: Dec. 20, 2018

Related U.S. Application Data
(60) Provisional application No. 62/613,578, filed on Jan. 4, 2018.

(51) Int. Cl. B60R 1/072; B60R 1/06

(52) U.S. Cl. CPC B60R 1/072; B60R 1/06

(57) ABSTRACT

A mirror assembly for a vehicle comprises a mount in connection with the vehicle and a mirror assembly. The assembly further comprises a motor assembly disposed in a housing of the mirror assembly. The motor assembly is in connection with the mount along a first axis and is in connection with the housing proximate a second axis. The motor assembly is configured to rotate the mirror assembly about the first axis and the second axis.

### CROSS REFERENCE TO RELATED APPLICATION

This application claims the benefit of and priority to U.S. Provisional Patent Application No. 62/613,578, filed on Jan. 4, 2018, entitled EXTERIOR MIRROR ASSEMBLY, the entire disclosure of which is hereby incorporated herein by reference.

### TECHNOLOGICAL FIELD

The present disclosure relates generally to a mirror assembly for a vehicle and, more particularly, relates to an exterior rearview mirror assembly for a vehicle.

### BACKGROUND OF THE INVENTION

Exterior mirror assemblies may be implemented on vehicles to improve visibility for operators and passengers of vehicles. The disclosure provides for an improved mirror assembly for use with various forms of vehicles.

### SUMMARY OF THE INVENTION

In one aspect, a mirror assembly for a vehicle is disclosed. The assembly comprises a mount in connection with the vehicle and a mirror assembly. The assembly further comprises a motor assembly disposed in a housing of the mirror assembly. The motor assembly is in connection with the mount along a first axis and is in connection with the housing proximate a second axis. The motor assembly is configured to rotate the mirror assembly about the first axis and the second axis.

In another aspect, a mirror assembly for a vehicle is disclosed. The assembly comprises a mount comprising a proximal end portion in connection with the vehicle and a distal end portion comprising a mounting surface. The assembly further comprises a mirror assembly comprising a housing. A motor assembly is disposed in the housing. The motor assembly comprises a first connecting assembly in connection with the mounting surface and a second connecting assembly in connection with the housing. The motor assembly is configured to orient the mirror assembly and the housing about a first axis and a second axis relative to the mounting surface.

In yet another aspect, a mirror assembly for a vehicle is disclosed. The assembly comprises a mount comprising a proximal end portion in connection with the vehicle and a distal end portion comprising a mounting surface. The assembly further comprises a mirror assembly comprising a housing. A motor assembly is disposed in the housing and configured to orient the mirror assembly and the housing about a first axis and a second axis relative to the mounting surface. The motor assembly comprises a first connecting assembly in connection with the mounting surface and a second connecting assembly in connection with the housing. The motor assembly is configured to control a horizontal orientation by rotating the mirror assembly including the reflective assembly about the first axis relative to the mount. The motor assembly is further configured to control a vertical orientation of the mirror assembly by rotating the mirror assembly including the reflective assembly about the second axis relative to the first axis.

These and other features, advantages, and objects of the present device will be further understood and appreciated by those skilled in the art upon studying the following specification, claims, and appended drawings.

### BRIEF DESCRIPTION OF THE DRAWINGS

The invention will now be described with reference to the following drawings, in which:

FIG. 1 is an elevational view of a vehicle comprising an exterior mirror assembly;

FIG. 2 is a front view of an exterior mirror assembly of a vehicle;

FIG. 3 is an exploded assembly view of an exterior mirror assembly;

FIG. 4A is a front view of an exterior mirror assembly demonstrating section lines A-A and B-B;

FIG. 4B is a cross-sectional view of the exterior mirror assembly shown in FIG. 4A sectioned along line A-A;

FIG. 4C is a cross-sectional view of the exterior mirror assembly shown in FIG. 4A sectioned along line B-B; and

FIG. 5 is a block diagram of a control system for an exterior mirror assembly in accordance with the disclosure.

### DETAILED DESCRIPTION OF EMBODIMENTS

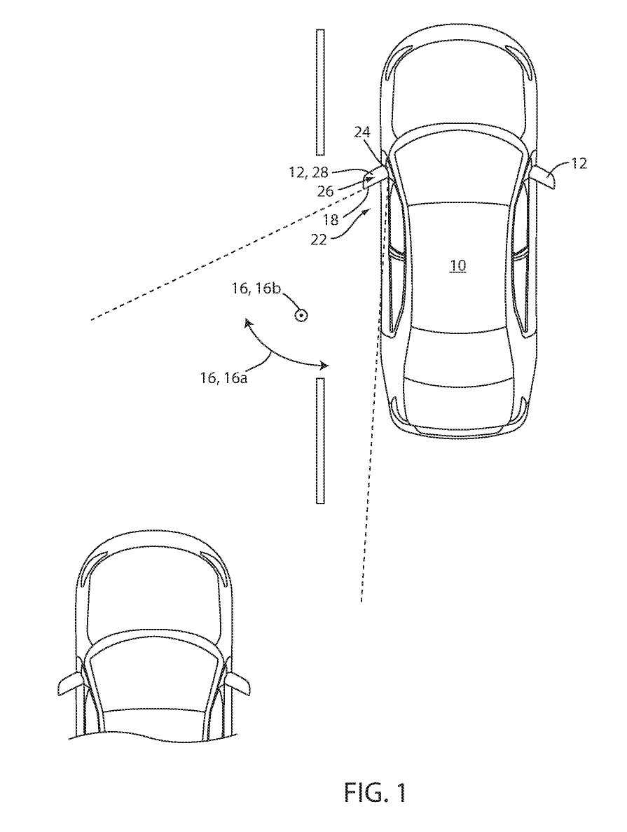

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

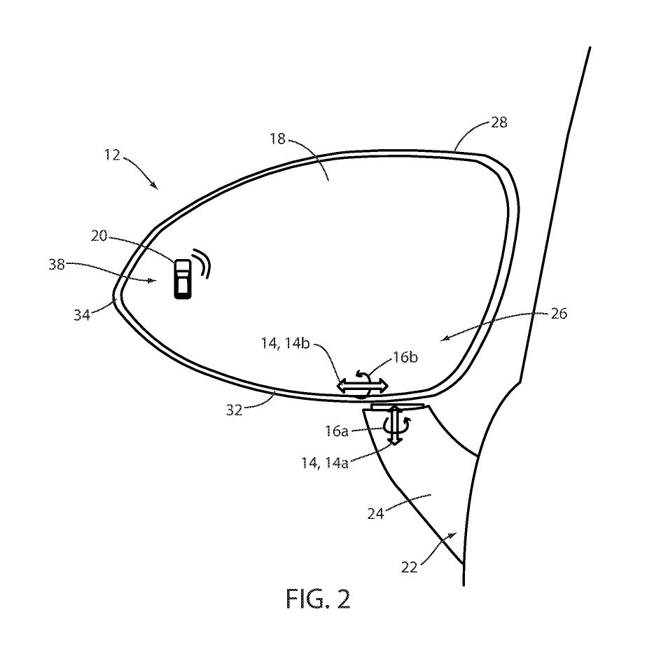

FIG. 1 demonstrates an elevational view of a vehicle 10 comprising at least one exterior mirror assembly 12. FIG. 2 demonstrates a front view of the exterior mirror assembly 12. Referring to FIGS. 1 and 2, the mirror assembly 12 may be configured to rotate about one or more axes 14 to adjust at least one field of view 16 of a mirror element 18 or display. The mirror element 18 may correspond to a reflective mirror element that may be manufactured of mirrored glass having a fixed reflectance. In some embodiments, the mirror element 18 may correspond to an electrochromic (EC) element configured to vary a reflectance of the mirror element 18. The mirror element 18 may comprise an indicia 20, which may correspond to an at least partially light emissive portion that may be ablated, cut and/or etched into the mirror element 18 such that light may be emitted therethrough.

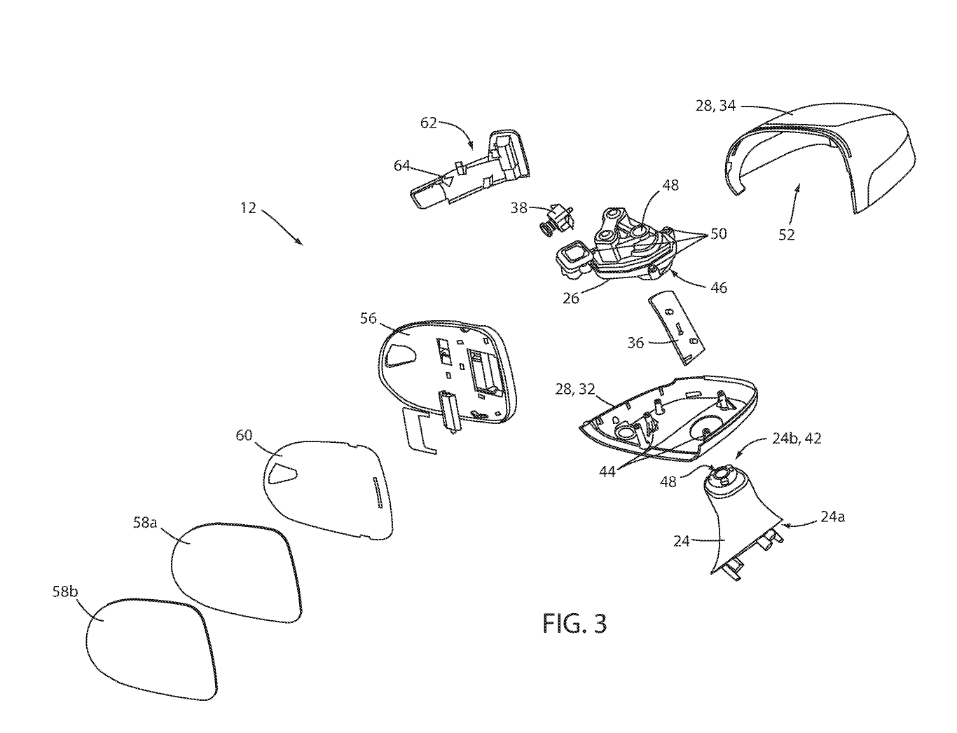

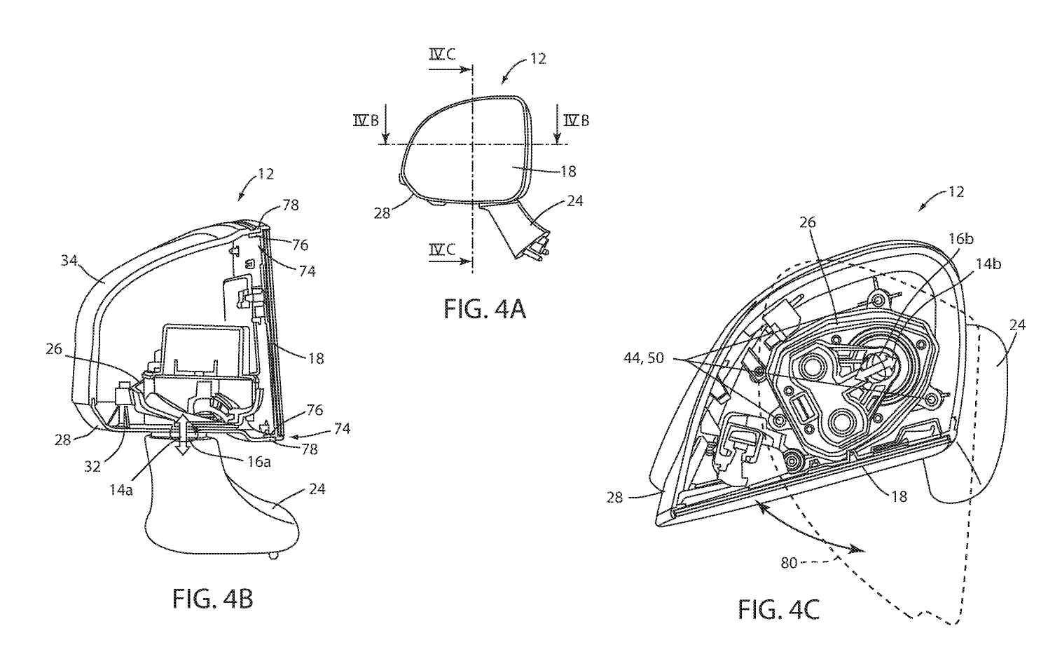

As demonstrated in FIG. 1, the mirror is in connection with an exterior portion 22 of the vehicle via a mount 24 or pedestal. The mirror assembly 12 may be configured to rotate about a first axis 14a normal to a mounting surface of the mount 24. In an exemplary embodiment, the mirror assembly 12 may be in connection with the mount 24 via a motor assembly 26, which may further be in connection with a housing 28 of the mirror assembly 12. In such configurations, the motor assembly 26 may be configured to rotate the mirror assembly 12 about the first axis 14a to adjust a first field of view 16a of the mirror element 18. In some embodiments, the motor assembly 26 may also be configured to rotate the mirror assembly 12 about a second axis 14b to adjust a second field of view 16b of the mirror element 18. The motor assembly 26 is further discussed in reference to FIGS. 3 and 4.

In the exemplary embodiment shown, the first field of view 16a may be a horizontal field of view while the second field of view 16b may correspond to a vertical field of view. The second field of view is demonstrated as an arrow point in FIG. 1 demonstrating that the second field of view 16b extends into and out of the drawing plane of FIG. 1. Accordingly, the first axis 14a may be substantially vertical and the second axis 14b may be substantially horizontal. In this configuration, the motor assembly 26 may be configured to adjust each of the first field of view 14a and the second field of view 14b in response to an input to a user interface of a controller in communication with the motor assembly 26. As described herein, the term substantially is used to define a range of relative positions similar to those described herein that may vary while providing the same effective arrangement. For example, a substantially horizontal line may vary +/−5 degrees while maintaining an effective adjustment of a vertical field of view. Accordingly, the term substantially should be interpreted to provide a meaningful range of measurements that may be understood by those having skill in the art to provide the similar or equivalent beneficial arrangements to the specific orientations and relationships discussed herein.

The housing 28 of the mirror assembly 12 may comprise a base plate 32 and a cover 34. The base plate 32 may be connected to the motor assembly 26, which may further be connected to the mount 24. The mirror element 18 may be affixed in an opening formed between the base plate 32 and the cover 34. Additionally, in some embodiments, the base plate 32 and the cover 34 may be connected via one or more trim panels 36 (shown in FIG. 3). In this configuration, the mirror element 18 may be constrained from motion relative to the mirror assembly 12. For example, the mirror element 18 may be connected to the mirror assembly 12 such that a movement of the mirror assembly 12 via the motor causes a corresponding movement and change in orientation of the mirror element 18. Accordingly, the motor assembly 26 may control the rotational orientation of the mirror assembly 12 and, consequently, also control an orientation of the mirror element 18 about the first axis 14a and the second axis 14b.

In some embodiments, an indicia 20 may be incorporated in the mirror element 18. The indicia 20 may correspond to various forms of icons, graphics, and/or indicators, which may be illuminated by a lighting module 38 disposed in the housing 28 of the mirror assembly 12. In this configuration, the lighting module 38 may be configured to illuminate the indicia 20 in response to various signals, some of which may correspond to detection indications and/or driver alerts, which may be communicated to the controller. The indicia 20 may be utilized for various functions, such as indications and driver assist functions, and may be illuminated by the lighting module 38 to provide for such functions. Driver assist functions may include, but are not limited to, turn signal indications, blind spot detection, obstacle detection, lane departure warning (LDW), or the like.

Referring now to FIG. 3, an exploded assembly view of the mirror assembly 12 and the mount 24 is shown. As previously described, the base plate 32 may be connected to the motor assembly 26, which may further be connected to the mount 24 or pedestal. The mount 24 may be in connection with the vehicle 10 at a proximal end portion 24a and connected to the motor assembly proximate to a distal end portion 24b. The motor assembly 26 may be connected to the mount 24 or pedestal via a first connecting assembly 42. The motor assembly may further connect to the base plate 32 of the mirror assembly 12 via a second connecting assembly 44. The first connecting assembly 42 may engage one or more pedestal connection apertures 46 located around an interior passage or wiring passage 48 of the motor assembly 26 extending from the proximal end portion 24a to the distal end portion 24b. The second connecting assembly 44 may engage one or more housing connecting apertures 50 formed by the motor assembly 26. In this configuration, the mirror assembly 12 may be connected to the mount 24 via the motor assembly 26.

The mirror element 18 may be in connection with the mirror assembly 12 via a carrier, which may be sealed or affixed within an opening 52 formed by the base plate 32 and the cover 34. In some embodiments, the mirror element 18 may comprise an electro-optic device 54. The electro-optic device 54 may comprise an electro-optic stack comprising a backing plate 56, a first substrate 58a, and a second substrate 58b. Additionally, a carrier plate 60 may be disposed between the backing plate 56 and the substrates 58a and 58b. The substrates 58a and 58b may be connected in a parallel, spaced apart configuration via one or more seals or spacers to form a chamber therebetween. An electro-optic medium may be enclosed in the chamber. In this configuration, the controller of the mirror assembly 12 may be configured to adjust a reflectivity of light reflected from the mirror element 18 by adjusting an electrical potential supplied to the one or more electrical clips in conductive communication with the electro-optic medium.

Various examples of electro-optic devices utilized in mirror elements may be found in U.S. Pat. No. 4,902,108, entitled “SINGLE-COMPARTMENT, SELF-ERASING, SOLUTION-PHASE ELECTROCHROMIC DEVICES SOLUTIONS FOR USE THEREIN, AND USES THEREOF,” issued Feb. 20, 1990, to H. J. Byker; Canadian Patent No. 1,300,945, entitled “AUTOMATIC REARVIEW MIRROR SYSTEM FOR AUTOMOTIVE VEHICLES,” issued May 19, 1992, to J. H. Bechtel et al.; U.S. Pat. No. 5,128,799, entitled “VARIABLE REFLECTANCE MOTOR VEHICLE MIRROR,” issued Jul. 7, 1992, to H. J. Byker; U.S. Pat. No. 5,202,787, entitled “ELECTRO-OPTIC DEVICE,” issued Apr. 13, 1993, to H. J. Byker et al.; and U.S. Pat. No. 5,204,778, entitled “CONTROL SYSTEM FOR AUTOMATIC REARVIEW MIRRORS,” issued Apr. 20, 1993, to J. H. Bechtel, each of which is incorporated herein by reference in its entirety.

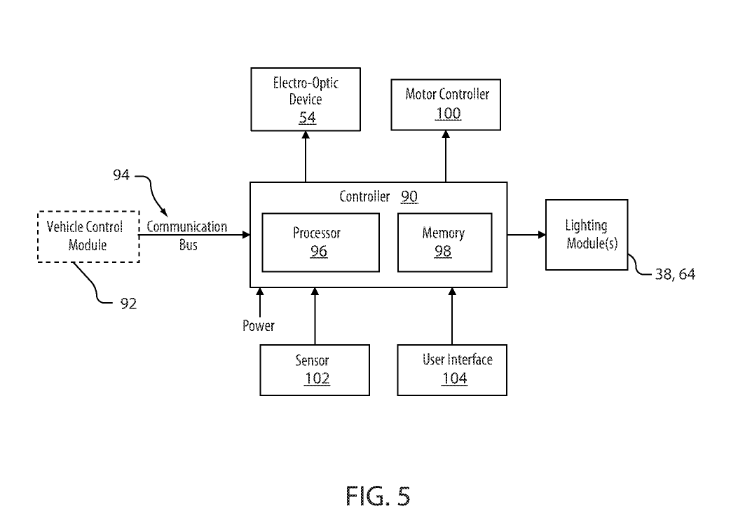

Control and power supply wiring or conductive connections may pass through the wiring passage 48, which may extend through the mount 24 or pedestal, into the motor assembly 26 and into a cavity formed inside the housing 28 between the base plate 32 and the cover 34. In this configuration, a mirror assembly controller may be in communication with a user interface and one or more vehicle controllers or control modules. A block diagram of an exemplary embodiment of the mirror assembly controller is shown in FIG. 5. The mirror assembly controller may be in connection with the backing plate 56 providing a central location for control of the motor as well as the electro-optic device 54 of the mirror element 18, the indicia 20, and/or one or more indicator lights.

In some embodiments, the mirror assembly 12 may further comprise an indicator assembly 62, which may be configured to function as a turn indicator. The indicator assembly 62 may comprise a lighting module 64 configured to project light outward from a forward and side directed portion of the mirror assembly 12. The indicator assembly 62 may be configured to connect to the mirror assembly 12 along a seam between the base plate 32 and the cover 34. Additionally, the indicator assembly 62 may be in communication with one or more vehicle control systems (e.g. a turn indicator system) via the conductive connections that pass through the internal wiring passage 48. As described herein, the indicator assembly 62 may be integrated with the mirror assembly 12 providing additional features to the assembly 62.

Referring now to FIGS. 4A, 4B, and 4C, cross-sectional views of the mirror assembly 12 are shown demonstrating the connection of the motor assembly 26 to the mount 24 and the mirror assembly 12. As previously discussed, the mirror assembly 12 may be in connection with the mount 24 via the motor assembly 26. The motor assembly 26 may further be in connection with the base plate 32 of the housing 28. In this configuration, the motor assembly 26 may be configured to rotate the mirror assembly 12 about the first axis 14a to adjust a first field of view 16a (e.g. horizontal field of view) of the mirror element 18. The motor assembly 26 may also be configured to rotate the mirror assembly 12 about the second axis 14b to adjust a second field of view 16b (e.g. vertical field of view) of the mirror element 18. In this configuration, the motor assembly 26 may be configured to adjust each of the first field of view 14a and the second field of view 14b in response to an input to a user interface of a controller in communication with the motor assembly 26.

As shown in FIG. 4B, the mirror element 18 may be affixed in the opening 52 formed between the base plate 32 and the cover 34 by an overlapping assembly feature 74, which may be formed by the backing plate 56 of the mirror element 18. The overlapping assembly feature 74 may comprise mating surfaces 76 (e.g. edges and surfaces) extending along the backing plate 56. The mating surfaces 76 may be configured to slidably engage complementary receiving features 78 (e.g. an aligned lip or edge) of the base plate 32 and the cover 34. In this configuration, the backing plate 56 of the mirror element 18 may connect the mirror element 18 to the housing 28 to form the mirror assembly 12. In this configuration, the mirror element 18 may be constrained from motion relative to the mirror assembly 12 such that the motor assembly 26 may control the orientation of the mirror element 18 about the first axis 14a and the second axis 14b.

As demonstrated in FIG. 4B, the mirror assembly 12 is shown angled toward the vehicle 10 such that a reflection of the mirror element 18 may be reflected inward toward an interior passenger compartment of the vehicle 10. That is, the mirror assembly 12 is shown rotated about the first axis 14a to adjust the first field of view 16a (e.g. the horizontal field of view) of the mirror element 18. Due to the rotation of the mirror assembly 12 about the first axis 14a, the orientation of the motor assembly 26 and the corresponding second axis 14b is also rotated such that the second axis 14b is biased toward a rear portion of the vehicle 10. In this configuration, the rotation about the second axis 14b may be adjusted relative to the rotation about the first axis 14a such that an adjustment of the second field of view 16b is adjusted relative to the rotation of the second axis 14b about the first axis 14a. This configuration may provide for intuitive control of the orientation of the mirror assembly 12 in response to orientation adjustments received from the user interface of the mirror assembly controller 90 (shown in FIG. 5).

The motor assembly 26 may correspond to a packaged motor assembly configured to provide for rotation about the first axis 14a and the second axis 14b. The motor assembly 26 may be connected to the mount 24 or pedestal via the first connecting assembly 42 and connected to the base plate 32 via a second connecting assembly 44. The first connecting assembly 42 may comprise one or more fasteners configured to engage one or more pedestal connection apertures 46 located around a wiring passage 48 of the motor assembly 26. The second connecting assembly 44 may also comprise one or more fasteners configured to engage the housing connecting apertures 50 formed by the motor assembly 26. In this configuration, the mirror assembly 12 may be connected to the mount 24 via the motor assembly 26.

In some embodiments, mirror assembly 12 may be configured to rotate to a folded position 80. An example of a folded position 80 is demonstrated with phantom lines in FIG. 4C. In this configuration, the motor assembly 26 may be configured to rotate the mirror assembly 12 about the first axis 14a to orient the mirror assembly 12 in the folded position 80. Accordingly, the mirror assembly 12 may provide for adjusting the orientation of the mirror to the folded position 80 to limit the extent that the mirror assembly 12 extends outward from the vehicle 10.

Referring now to FIG. 5, a block diagram of a controller 90 for the mirror assembly 12 is shown. The controller 90 may be in communication with a vehicle control module 92 via a communication bus 94 of the vehicle 10. The communication bus 94 may be configured to deliver signals to the controller 90 identifying various states of the vehicle 10. For example, the communication bus 94 may be configured to communicate an operating condition of the vehicle 10 (e.g. an ambient light level, a driver assist signal, a blind spot detection, a turn indicator signal, lane departure warning, etc.). In this way, the controller 90 may selectively activate one or more indicators or indicia of the mirror assembly 12 in response to one or more conditions communicated by the vehicle control module 92.

The controller 90 may include a processor 96 comprising one or more circuits configured to receive the signals from the communication bus 94 and output signals to control the mirror assembly 12 discussed herein. The processor 96 may be in communication with a memory 98 configured to store instructions to control the activation of a motor controller 100 as well as the indicators or indicia. The processor 96 may receive various signals and/or messages corresponding to vehicle conditions via the communication bus 94 and various sensors in communication with the controller 90. For example, the controller 90 may be in communication with at least one sensor 102, for example, a blind spot monitor, a collision avoidance sensor, a glare light sensor, or any form of sensor. The sensor 102 may correspond to a sensor for a driver assist system. The blind spot sensor may correspond to a variety of sensors, for example, a laser sensor, sonar-based sensor, ultrasonic sensor, a video or image-based sensor, or any form of sensor that may provide a driver assist function.

The controller 90 may further be in communication with a user interface 104, which may comprise one or more buttons or switches disposed in a passenger compartment of the vehicle 10. In this configuration, a user or operator of the vehicle 10 may control a position of the mirror assembly 12 via the user interface 104. In response to receiving one or more signals or inputs from the user interface 104, the controller 90 may communicate with the motor controller 100 to control an orientation of the mirror assembly 12 about the first axis 14a and the second axis 14b.

The controller 90 may further be in communication with the lighting module 38 of the indicia 20, the lighting module 64 of the indicator assembly 62, and the electro-optic device 54 of the mirror element 18. In this way, the controller 90 may be configured to control the lighting modules 38 and 64 in response to a variety of signals received by the controller 90 including, but not limited to, turn signal indications, blind spot detections, obstacle detections, lane departure warnings (LDW), etc. The controller 90 may also be configured to control a reflectivity of light reflected from the electro-optic device 54 by adjusting an electrical potential supplied to the one or more electrical clips in conductive communication with the electro-optic medium. In some embodiments, the mirror assembly 12 may further comprise a heating element in communication with the controller 90. The heating element may be selectively activated by the controller 90 based on defrost or defog instructions received via the communication bus 94.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A mirror assembly for a vehicle comprising:
a mount in connection with the vehicle;
a mirror assembly comprising a housing; and
a motor assembly disposed in the housing of the mirror assembly, wherein the motor assembly is in connection with the mount along a first axis and is in connection with the housing proximate to a second axis, wherein the motor assembly is configured to rotate the mirror assembly about the first axis and the second axis.

2. The mirror assembly according to claim 1, wherein the mount comprises a stationary pedestal configured to connect a base portion of the mirror housing to the vehicle.

3. The mirror assembly according to claim 1, wherein the mount is in connection with the vehicle at a proximal end portion and connected to the motor assembly proximate to a distal end portion.

4. The mirror assembly according to claim 3, wherein the distal end portion comprises a mounting surface, wherein the first axis is arranged substantially normal to the mounting surface.

5. The mirror assembly according to claim 4, wherein the motor assembly comprises a first connecting assembly in connection with the mounting surface.

6. The mirror assembly according to claim 5, wherein the motor assembly comprises a second connecting assembly in connection with the housing.

7. The mirror assembly according to claim 6, wherein the motor assembly is configured to orient the housing about the first axis and the second axis relative to the mounting surface.

8. The mirror assembly according to claim 3, wherein the mount forms an interior passage extending from the proximal end portion to the distal end portion.

9. The mirror assembly according to claim 8, wherein the interior passage is configured to receive at least one conductive connector extending from the vehicle to the housing.

10. The mirror assembly according to claim 1, wherein the first axis is oriented in a substantially vertical direction and the second axis is oriented in a substantially horizontal direction.

11. The mirror assembly according to claim 1, wherein the mirror assembly comprises a cover plate and a base plate affixed to a reflective assembly.

12. The mirror assembly according to claim 11, wherein the motor is in connection with the base plate of the mirror assembly.

13. The mirror assembly according to claim 11, wherein the motor assembly is configured to control a horizontal orientation and a vertical orientation of the mirror assembly by:
rotating the mirror assembly including the reflective assembly about the first axis relative to the mount; and
rotating the mirror assembly including the reflective assembly about the second axis relative to the first axis.

14. The mirror assembly according to claim 1, wherein the second axis is substantially perpendicular to the first axis.

15. The mirror assembly according to claim 1, wherein the first axis is configured to rotate the mirror assembly controlling a horizontal orientation.

16. The mirror assembly according to claim 1, wherein the second axis is configured to rotate the mirror assembly controlling a vertical orientation.

17. A mirror assembly for a vehicle comprising:
a mount comprising a proximal end portion in connection with the vehicle and a distal end portion comprising a mounting surface;
a mirror assembly comprising a housing; and
a motor assembly disposed in the housing and comprising:
a first connecting assembly in connection with the mounting surface;
a second connecting assembly in connection with the housing, wherein the motor assembly is configured to orient the mirror assembly and the housing about a first axis and a second axis relative to the mounting surface.

18. The mirror assembly according to claim 17, wherein the mount comprises a stationary pedestal configured to connect the motor assembly to the vehicle.

19. The mirror assembly according to claim 17, wherein the first axis is arranged substantially normal to the mounting surface.

20. A mirror assembly for a vehicle comprising:
a mount comprising a proximal end portion in connection with the vehicle and a distal end portion comprising a mounting surface;
a mirror assembly comprising a housing; and
a motor assembly disposed in the housing and configured to orient the mirror assembly and the housing about a first axis and a second axis relative to the mounting surface, the motor assembly comprising:
a first connecting assembly in connection with the mounting surface;
a second connecting assembly in connection with the housing, wherein the motor assembly is configured to:
control a horizontal orientation rotating the mirror assembly including the reflective assembly about the first axis relative to the mount; and
control a vertical orientation of the mirror assembly rotating the mirror assembly including the reflective assembly about the second axis relative to the first axis.
